(19) United States
(12) Patent Application Publication
(10) Pub. No.: US 2013/0171432 A1
(43) Pub. Date: Jul. 4, 2013

(54) EXERCISE MAT

(71) Applicant: LULULEMON ATHLETICA CANADA INC., Vancouver (CA)

(72) Inventors: YOGENDRA V. DANDAPURE, RICHMOND (CA); KATHERINE DOUGLAS, VANCOUVER (CA)

(73) Assignee: LULULEMON ATHLETICA CANADA INC., VANCOUVER (CA)

(21) Appl. No.: 13/728,221

(22) Filed: Dec. 27, 2012

Related U.S. Application Data
(60) Provisional application No. 61/580,961, filed on Dec. 28, 2011.

(51) Int. Cl. A63B 21/00; B32B 5/02; B32B 38/00; B32B 3/10

(52) U.S. Cl. CPC A63B 21/1473; B32B 3/10; B32B 5/026; B32B 38/0004; B32B 38/145
USPC 428/197; 428/195.1; 428/196; 156/246

(57) ABSTRACT

An exercise mat comprising: a bottom layer; and a top layer comprising an absorbent material and a traction enhancing material printed on the top layer.

### CROSS-REFERENCE TO RELATED APPLICATIONS

This application is based on and derives the benefit of the filing date of U.S. Provisional Patent Application No. 61/580,961, filed Dec. 28, 2011. The entire content of this application is herein incorporated by reference in its entirety.

### BRIEF DESCRIPTION OF THE DRAWINGS

FIGS. 1-6 depict various views of an exercise mat, according to an embodiment of the present invention.

FIG. 7 depicts three layers of an exercise mat, according to an embodiment of the present invention.

### DETAILED DESCRIPTION OF SEVERAL EMBODIMENTS

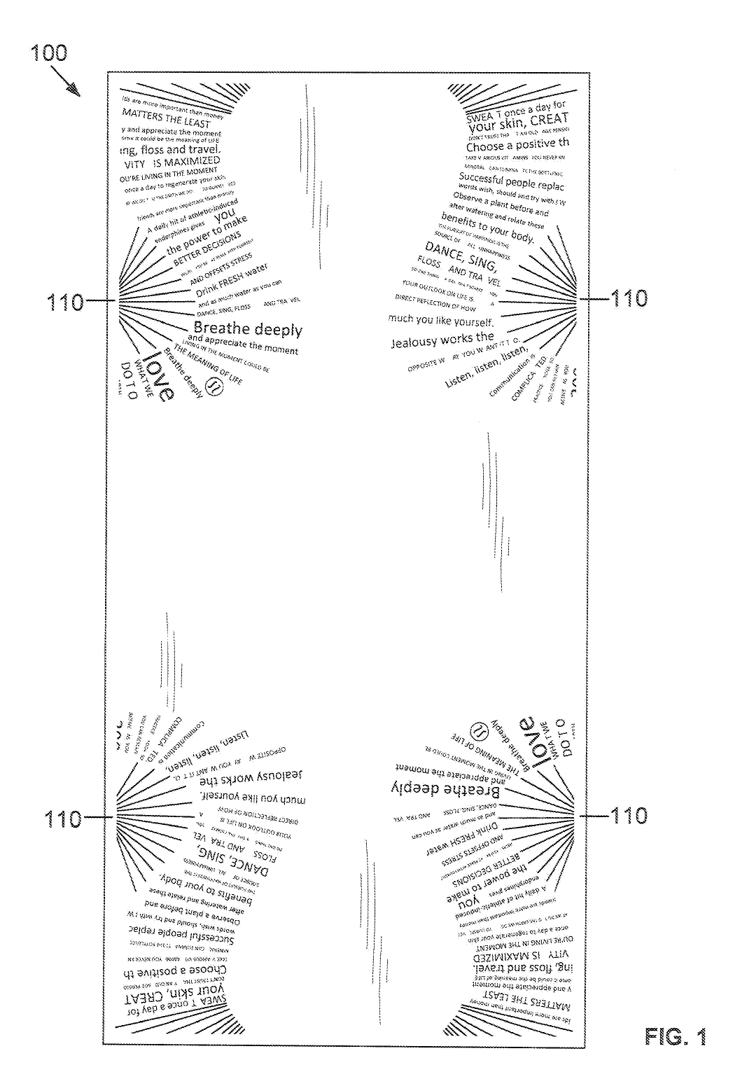

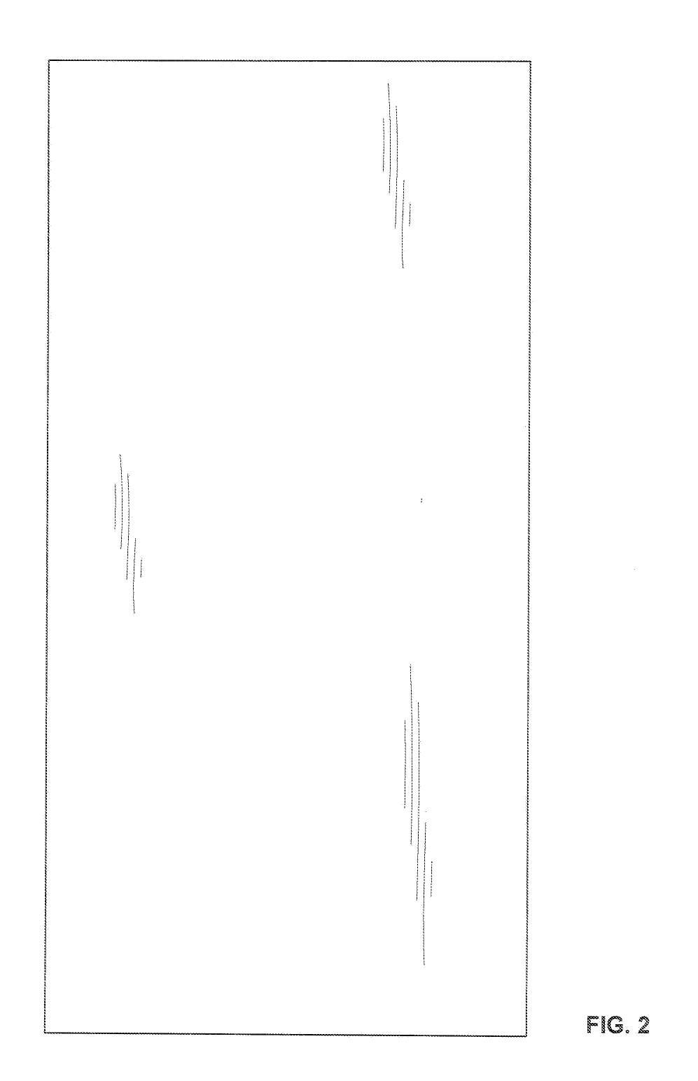

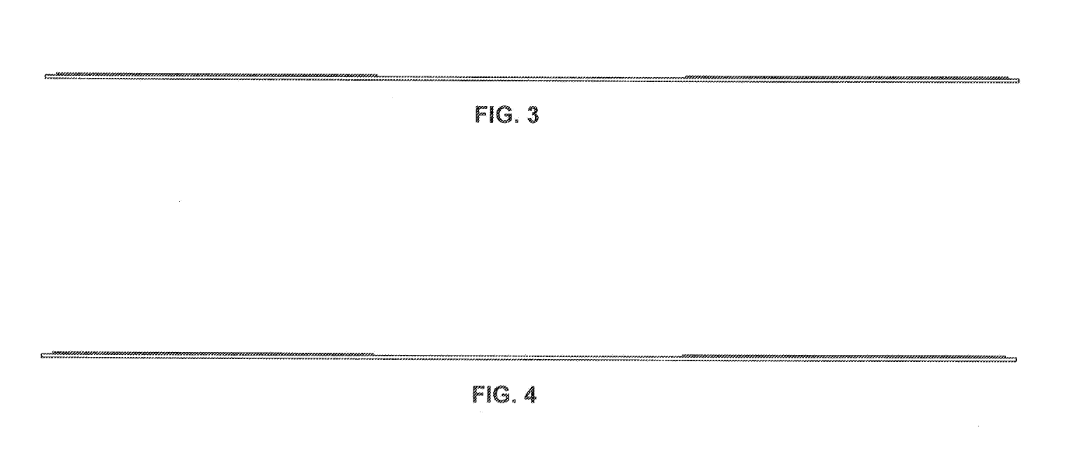

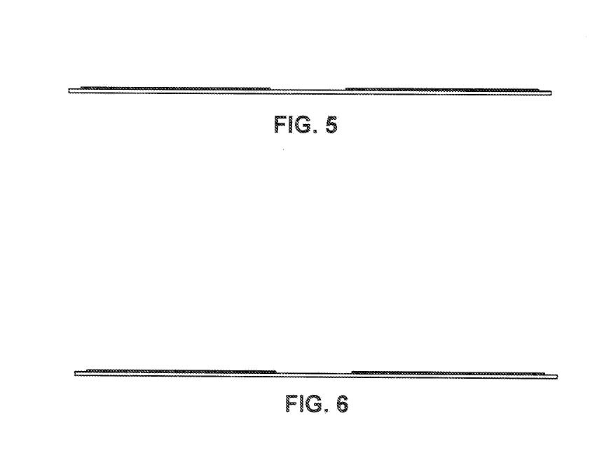

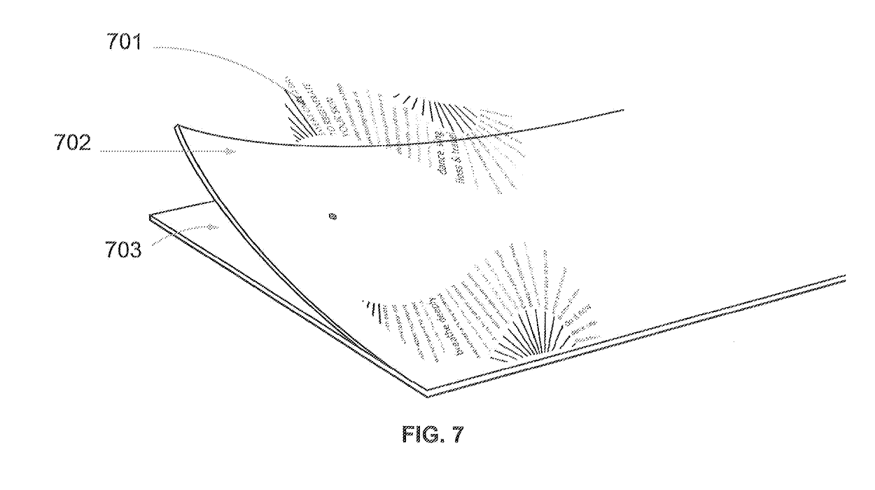

FIGS. 1-6 depict various views of an exercise mat 100, according to an embodiment of the invention. FIG. 1 depicts a top-down view of an exercise mat 100 according to an embodiment of the present invention. FIG. 2 depicts a bottom view of the exercise mat 100. FIGS. 3-6 depict side views of the exercise mat 100. The exercise mat 100 may be placed on a flat surface by a user to provide cushioning and grip, allowing the user to more easily and effectively perform exercises (e.g., yoga, etc.). The exercise mat 100 can comprise several layers of varying materials and structures disposed atop one another. For example, FIG. 7 depicts three layers that can be part of the exercise mat 100; a bottom layer 703 (e.g., of natural rubber), a top first material 702 (e.g., of polyester nylon blend microfiber knitted fabric), and a top second material 701 (e.g., printed material in silicone, acrylic, TPE material, or any combination thereof).

FIG. 1 depicts a rectangular exercise mat 100 of sufficient size to support a typical user's body through a wide range of exercise positions. Example sizes may include, but are not hunted to widths of 24 inches to 30 inches and lengths of 70 inches to 78 inches. Although a rectangular exercise mat 100 is shown in FIG. 1A, it should be noted that the exercise mat 100 may have other shapes, such as a square, circle, or oval, or any other shape or design. Embodiments of the exercise mat 100 may be constructed in such a way that the exercise mat 100 may be machine washed, tumble dried, or folded, or any combination thereof. Embodiments of the exercise mat 100 may be made suitable for use on various surfaces, comprising: hard floors, carpeted floors, other mats (e.g., rubber, PVC, TPE, and/or EVA mats), or other surfaces, or any combination thereof.

The exercise mat 100 may comprise a top layer. In some embodiments, the top layer may be made of an absorbent fabric material. For example, the top layer may be made of an absorbent fiber, micro fiber, super micro fiber, and/or nano fiber fabric made of 50-100% polyester and/or 50-100% nylon, a blend of regenerated cellulose or polyester fibers, or any combination thereof. Other material types and compositions are possible. In some embodiments, the top layer may be assembled using warp knitted construction, which may result in a top layer with non-running edges. An absorbent top layer may absorb moisture such as the perspiration of a user who is exercising on the exercise mat 100. The top layer may also be treated with an antimicrobial agent. Examples of antimicrobial agents may comprise silver based antimicrobial and/or 3-trimethoxy silyl propyl dimethyl octadecyl ammonium chloride. However, other antimicrobial agents may also be employed. (It should be noted that any layer of any exercise mat described herein may also be treated with an antimicrobial agent.)

The top layer may comprise a second material which may be printed or otherwise applied to a surface of the top layer. The second material may be a material that can provide friction and/or traction. The second material may be used by a user to prevent slipping on the top layer of the exercise mat 100 or it may be placed in contact with a floor to prevent slipping of the exercise mat 100 itself. The second material may be a PVC and phthalate free acrylic material, a PVC and phthalate free silicone material, or any other material, or any combination thereof. In some embodiments, the second material may be printed onto the top layer. In the example of FIG. 1, the second material 110 is printed in a pattern along two sides of the exercise mat 100. This pattern and positioning may provide grip surfaces for a user's hands and/or feet when the user is exercising on the exercise mat 100. For examples of suitable traction enhancing materials and applications, see U.S. Pat. No. 7,137,157, the entirety of which is incorporated by reference herein.

The exercise mat 100 can also have a bottom layer. This bottom layer can provide friction and/or traction (e.g., in wet and/or dry conditions), so that when it is placed in contact with a floor by a user, the exercise mat 100 does not slide when the user utilizes the exercise mat 100 (e.g., for yoga or another exercise). The bottom layer can also provide cushioning for a user of the exercise mat 100. In some embodiments, the bottom layer may be provided with a textured surface to enhance grip. The bottom layer may be made of a thermoplastic elastomer, polyvinyl chloride, polyurethane, natural rubber, synthetic rubber, rubber blends, EVA foam, or another material which provides cushioning, or any combination thereof. In other embodiments, the bottom layer may be made of rubber, including natural rubber, synthetic rubber, or a blend of the two, or mix of natural rubber, synthetic rubber and thermoplastic elastomers as well as the above-mentioned materials, or any combination thereof. In some embodiments, the bottom layer may also be made of a suitable material which can help the exercise mat 100 hold its shape, provide cushioning, provide flexibility, provide wear and tear resistance, or provide support, or any combination thereof; or a material that bonds well with the top layer; or any combination thereof. The bottom layer may also be treated with an antimicrobial agent. Examples of antimicrobial agents may comprise: silver based antimicrobial and/or 3-trimethoxy silyl propyl dimethyl octadecyl ammonium chloride. However, other antimicrobial agents may also be employed. (It should be noted that any layer of any exercise mat described herein may also be treated with an antimicrobial agent.)

The various layers described above may be bonded to one another using any suitable bonding technique. In some embodiments, the layers may have thermoplastic bonding properties that cause adjacent layers to bond with one another when heated. For example, a rubber bottom layer may be thermally bonded to a fabric top layer. In this case, one method of manufacture may comprise preparing and mixing a rubber compound that may serve as the bottom layer. After mixing, the rubber compound may be calendared or flattened to a desired width and thickness, formed into the bottom layer, and fed into an oven with a fabric top layer for curing (e.g., rubber mixing and a calendaring machine may be used to form a thin sheet of rubber). Pressure may be applied to the top fabric and the bottom rubber sheet before and/or while they are fed into the oven (e.g., by calendaring the fabric and rubber sheet together). Heat may be applied to the top and bottom layers, which may cause the top and bottom layers to bond to one another and may also cause curing and/or foaming of the rubber. The top and bottom layers may be transported on a belt though heated chamber(s).

In another example, a thermoplastic elastomer and/or synthetic rubber bottom layer may be thermally bonded to a fabric top layer. In this case, the top and bottom layers may be formed as in the rubber example set forth above or by any other method. A thin film of thermoplastic elastomer may be applied between the top layer and bottom layer in some embodiments. The top and bottom layers, and the thin film between these layers, if applicable, may be fed into an oven and heated for curing and/or foaming. Pressure may be applied to the top and bottom layers, and a film, if applicable, before and/or while they are fed into the oven. Alternatively, layers may be bonded using other adhesives such as glues and/or mechanical connections. In addition, any combination of these methods or any other method may be utilized.

In addition to bonding, manufacturing processes for embodiments of the exercise mat 100 may comprise printing and/or application of the second material to the first material of the top layer. The top second material may be applied in ink form using a printing process in some embodiments. For example, in some embodiments an ink of the second material may be printed onto the surface of the first material, flash dried, reprinted, and cured, using, for example, a heated chamber. In other embodiments, printing may be done utilizing screen printing, where screens may be placed on the top layer and squeezies may be used to print the ink on the top layer and then cured through a hot chamber. For example, a silicone ink may be printed onto the surface of the first material using this process and cured at approximately 200° C. for approximately 90 seconds. After curing, the exercise mat 100 may be aired out. In some embodiments, the printed layer may be approximately 5%, the fabric layer may be approximately 27% and the bottom layer may be approximately 68%.

Note that the terms “top layer” and “bottom layer” in the embodiments above are used for ease of explanation only. Either the top layer or the bottom layer may be placed in contact with a floor by a user, with the opposite side forming an exercise surface for the user. This may allow a user to use different layer characteristics to enhance different exercises. For example, a user may use the top layer, which may have moisture absorbing properties, as an exercise surface when the user anticipates sweating. The user may use the bottom layer, which may have high friction and/or cushioning properties, as an exercise surface when the user does not anticipate sweating. A user may also use either or both of the top layer and bottom layer for other purposes not limited to exercise.

### Example Embodiments

In some embodiments, the following may be utilized: The bottom layer may be a foamed natural rubber based compound with 3-trimethoxy silyl propyl dimethyl octadecyl ammonium chloride as an antimicrobial, anti fungal agent. The top layer may be a warp knitted 80% super micro polyester, 20% Nylon 300 grams per square meter fabric, treated with ionic silver for antimicrobial properties. Acrylic based ink may be printed on the top layer using a screen printing technique. The size may be approximately 26 inches by approximately 71 inches, although any size may be utilized.

In some embodiments, the following manufacturing method may be utilized: An absorbent fabric, such as a seaisland yarn may be warp knitted, dyed, finished and sueded on both sides. A natural rubber compound may be prepared using various fillers, foaming, antimicrobial, antioxidizing, or odor absorbing agents, or any combination thereof. The rubber compound may be mixed and calendared onto a conveyer belt, where the super micro fiber fabric may be fed together with the flattened rubber layer and both the layers may be heat bonded by passing in or through an oven for approximately 5 to 7 minutes under approximately 120 to 150 degree C. heat. During this process the rubber may become bonded to the fabric as well as becoming cured and foamed. The laminated material may be cooled down and wound on a roller and taken to a die cutting machine, where the laminated material may be cut into a mat shape (e.g., approximately 26 inches by 71 inches, although any size may be utilized). The laminated mat may then be printed with acrylic based printing ink (e.g., throughout the entire mat, on one or both ends of the mat). Two strokes of print may be applied and the material may be passed in or through an oven (e.g., using a conveyer belt) for curing the printing ink at approximately 170 to 200 degree C. temperature and approximately 45 to 120 seconds of time. The finished mat may be cooled down, rolled, and packed.

### CONCLUSION

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown.

Further, the purpose of any Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. An Abstract of the Disclosure is not intended to be limiting as to the scope of the present invention in any way.

Although the term “at least one” may often be used in the specification, claims and drawings, the terms “a”, “an”, “the”, “said”, etc. also signify “at least one” or “the at least one” in the specification, claims and drawings.

Additionally, the term “comprising” or similar terms in the specification, claims and drawings should be interpreted as meaning “including, but not limited to.”

Finally, it is the applicant's intent that only claims that include the express language “means for” or “step for” be interpreted under 35 U.S.C. 212, paragraph 6. Claims that do not expressly include the phrase “means for” or “step for” are not to be interpreted under 35 U.S.C. 212, paragraph 6.

What is claimed is:

1. An exercise mat comprising:
a bottom layer; and
a top layer comprising an absorbent material and a traction enhancing material printed on the top layer.

2. The exercise mat of claim 1, wherein the bottom layer comprises: a thermoplastic elastomer, a polyvinyl chloride, a polyurethane, a natural rubber, a synthetic rubber, a rubber blend, or an EVA foam, or any combination thereof.

3. The exercise mat of claim 1, wherein the bottom layer is configured to provide traction when placed in contact with a surface.

4. The exercise mat of claim 1, wherein the absorbent material comprises: an absorbent fiber, a micro fiber, a super micro fiber, a nano fiber fabric made of 50-100% polyester and/or 50-100% nylon, or a blend of regenerated cellulose or polyester fibers, or any combination thereof.

5. The exercise mat of claim 1, wherein the absorbent material comprises a warp knitted material.

6. The exercise mat of claim 1, wherein the traction enhancing material comprises a PVC and phthalate free acrylic material, or a PVC and phthalate free silicone material, or any combination thereof.

7. The exercise mat of claim 1, wherein the traction enhancing material is disposed on an outer surface of the absorbent material in a pattern.

8. The exercise mat of claim 1, wherein the traction enhancing material is printed on an outer surface of the absorbent material.

9. The exercise mat of claim 1, wherein an inner surface of the top layer and an inner surface of the bottom layer are laminated to one another.

10. The exercise mat of claim 1, wherein the top layer and/or the bottom layer comprises an antimicrobial agent.

11. The exercise mat of claim 1, wherein the exercise mat is constructed and arranged to be machine washed and/or tumble dried.

12. An exercise mat comprising:
a bottom layer configured to provide traction when placed in contact with a surface; and
a top layer comprising a warp knitted absorbent material and a traction enhancing material printed on an outer surface of the absorbent material;
wherein an inner surface of the top layer and an inner surface of the bottom layer are laminated to one another.

13. The exercise mat of claim 12, wherein the bottom layer comprises: a thermoplastic elastomer, a polyvinyl chloride, a polyurethane, a natural rubber, a synthetic rubber, a rubber blend, or an EVA foam, or any combination thereof.

14. The exercise mat of claim 12, wherein the absorbent material comprises: an absorbent fiber, a micro fiber, a super micro fiber, a nano fiber fabric made of 50-100% polyester and/or 50-100% nylon, or a blend of regenerated cellulose or polyester fibers, or any combination thereof.

15. The exercise mat of claim 12, wherein the traction enhancing material comprises: a PVC and phthalate free acrylic material, or a PVC and phthalate free silicone material, or any combination thereof.

16. The exercise mat of claim 12, wherein the traction enhancing material is disposed on an outer surface of the absorbent material in a pattern.

17. The exercise mat of claim 12, wherein the traction enhancing material is printed on an outer surface of the absorbent material.

18. The exercise mat of claim 12, wherein an inner surface of the top layer and an inner surface of the bottom layer are laminated to one another.

19. The exercise mat of claim 12, wherein the top layer and/or the bottom layer comprises an antimicrobial agent.

20. The exercise mat of claim 12, wherein the exercise mat is constructed and arranged to be machine washed and/or tumble dried.

21. An exercise mat comprising:
a bottom layer configured to provide traction when placed in contact with a surface, the bottom layer comprising a foamed natural rubber-based compound with an antimicrobial agent comprising 3-trimethoxy silyl propyl dimethyl octadecyl ammonium chloride; and
a top layer comprising a warp knitted absorbent material comprising 80% super micro polyester and 20% nylon, the top layer treated with an antimicrobial agent comprising ionic silver; and
a traction enhancing acrylic material printed on an outer surface of the top layer.

22. The exercise mat of claim 21, wherein the traction enhancing material comprises: a PVC and phthalate free acrylic material, or a PVC and phthalate free silicone material, or a combination thereof.

23. The exercise mat of claim 21, wherein the traction enhancing material is disposed on an outer surface of the absorbent material in a pattern.

24. The exercise mat of claim 21, wherein the traction enhancing material is printed on an outer surface of the absorbent material.

25. The exercise mat of claim 21, wherein the top layer and/or the bottom layer comprises an antimicrobial agent.

26. The exercise mat of claim 21, wherein the exercise mat is constructed and arranged to be machine washed and/or tumble dried.

27. The exercise mat of claim 21, wherein an inner surface of the top layer and an inner surface of the bottom layer are laminated to one another.

28. A method of manufacturing an exercise mat, comprising:
pouring a bottom layer onto a conveyor belt, the bottom layer comprising a foamed natural rubber-based compound with an antimicrobial agent comprising 3-trimethoxy silyl propyl dimethyl octadecyl ammonium chloride;
pouring a top layer onto the bottom layer, the top layer comprising a warp knitted absorbent material comprising 80% super micro polyester and 20% nylon;
heating the bottom layer and top layer in an oven, wherein the inner surface of the bottom layer and the inner surface of the top layer are laminated to each other in a mat;
cooling the mat;
wounding the mat on a roller
cutting the mat into a rectangular shape;
printing a traction enhancing acrylic material on an outer surface of the top layer of the mat; and
heating the mat in an oven such that the traction enhancing acrylic material is laminated to the outer surface of the top layer of the mat.

29. The method of claim 28, wherein the bottom layer and top layer are laminated together by being heated in the over for approximately 5-7 minutes at approximately 120-150 degrees C.

30. The method of claim 28, wherein the traction enhancing acrylic material is laminated to the outer surface of the top layer of the mat by being heated in the over for approximately 45-120 seconds at approximately 170-200 degrees C.
